(19) United States
(12) Patent Application Publication
(10) Pub. No.: US 2015/0233027 A1
(43) Pub. Date: Aug. 20, 2015

(54) Hybrid Cord for Tire

(71) Applicant: Hyosung Corporation, Seoul (KR)

(72) Inventors: Mun Gyu SUNG, Busan (KR); Jong IL HWANG, Seoul (KR); Dong Hyun PARK, Seoul (KR)

(21) Appl. No.: 14/623,717

(22) Filed: Feb. 17, 2015

(30) Foreign Application Priority Data
Feb. 18, 2014 (KR) 2014-0018318

(51) Int. Cl. D02G 3/48; D07B 1/06; B60C 9/00; D02G 3/36

(52) U.S. Cl. CPC D02G 3/48; D02G 3/36; D07B 1/062; B60C 9/005

(57) ABSTRACT

Disclosed is a hybrid cord in which fiber is used for a core wire so as to facilitate rubber permeation into a steel cord, and thus fretting wear of the steel cord due to a repeated collision between the steel cords may be prevented, and moisture movement may be prevented even when the moisture permeates.

### CROSS-REFERENCE TO RELATED APPLICATION

This application claims priority to and the benefit of Korean Patent Application No. 2014-0018318, filed on Feb. 18, 2014, the disclosure of which is incorporated herein by reference in its entirety.

### BACKGROUND

1. Field of the Invention

The present invention relates to a hybrid cord for a tire, and more particularly, to a fiber-steel hybrid cord in which a core wire formed of fiber and a side wire formed of a steel wire are coupled with each other.

2. Discussion of Related Art

Among various kinds of reinforcing members which are used in various rubber products such as vehicle tires and industrial belts, a steel cord has excellent properties in terms of strength, modulus, thermal resistance, heat transfer rate, fatigue resistance, adhesiveness to rubber, and the like, and therefore, is widely used specially as a tire reinforcing member, and the used amount thereof is also being increased.

Generally, the steel cord is formed of carbon steel having a carbon content of 0.6 to 1.05 wt % so as to have a final wire diameter of 0.08 to 0.5 mm. A surface thereof is plated with brass or bronze so as to have adhesiveness to rubber. The steel cord is formed to have various twisted structures depending on its application.

In the steel cord, in case rubber does not permeate due to tightness of the twisted structure during a curing process, a tread cut phenomenon may occur, and thus water may permeate into a space between the steel cords. Therefore, the steel cord is corroded, physical properties thereof are deteriorated, a life span of a tire is considerably reduced, and also it may have a severe influence on vehicle safety.

Further, in a conventional steel cord, a core filament and a side filament are formed of the same carbon steel. Therefore, when a fretting phenomenon occurs between the core filament and the side filament, the side filament may be worn out, and thus durability of the tire may be reduced.

To solve the above problems, in case of a single twisted cord, Japanese Patent Laid-Open Publication No. Pyung 55-90692 disclose an example of an open cord in which the open cord is loosely twisted so that rubber may easily permeate.

In case of a multi-twisted cord, there was an example wherein a preformed cord in which a corrugated deformation is provided at an internal core wire is applied so as to increase a gap between side wires, such that rubber permeability is enhanced, and thus the corrosion problem is solved.

However, in the open cord, the rubber permeability is enhanced, but strength of the steel cord is lowered, and also the steel cord stretches easily in a lengthwise direction, and a dimension thereof is unstable. In the preformed cord, the strength of the steel cord and stability of a cord structure are lowered.

Meanwhile, to ensure sufficient strength and enhanced rubber permeability, a plurality of patents including U.S. Pat. No. 8,166,741 consider a method in which an elastomer such as fiber and plastic is inserted between cords. However, a commercialized example thereof is not yet reported. It seems that this is closely related with absorbing capability of the elastomer and a capillary phenomenon due to a structural shape of the elastomer, and is because performance deviation of the tire due to corrosion of the steel cord occurs largely depending on selection of the elastomer.

### SUMMARY OF THE INVENTION

The present invention is directed to a hybrid cord for a tire in which a core wire is formed of fiber, and a side wire is formed of a steel wire, and the core wire and the side wire are coupled in a structure of 1+N (N is an integer of 3 to 15) so as to facilitate rubber permeation and thus to prevent a fretting phenomenon between the core wire and the side wire, and the wire capable of preventing absorption and movement of moisture is selected so as to prevent performance deterioration of a steel cord due to corrosion.

According to an aspect of the present invention, there is provided a hybrid cord formed in a 1+N structure in which a core wire is wrapped with a side wire, and N is an integer of 3 to 15, wherein the core wire is selected from the group consisting of polyethylene terephthalate fiber, polypropylene fiber, polyester fiber, polyvinyl chloride fiber, polyketone fiber, carbon fiber, and dried aramid fiber, and the side wire is a steel wire.

The core wire may be a multi-filament formed of a bundle of large-diameter mono-filament fibers or fine-diameter mono-filament fibers.

When the multi-filament formed of a bundle of the fine-diameter mono-filament fibers is used as the core wire, moisture may be moved between the fine-diameter mono-filament fibers due to a capillary phenomenon, and thus the cord may be corroded. To prevent this corrosion, the multi-filament may be impregnated with a thermosetting resin or a thermoplastic resin so as to fill a space between the filament fibers, or may be treated through a water repellent process so as to prevent permeation or movement of the moisture.

A diameter of the core wire may be 0.15 to 0.7 mm, and a diameter of the side wire may be 0.15 to 0.5 mm.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a view schematically illustrating a conventional steel cord; and

FIG. 2 is a view illustrating various structures of a hybrid cord in accordance with the present invention.

### DETAILED DESCRIPTION OF EXEMPLARY EMBODIMENTS

The present invention will be described in detail below with reference to the accompanying drawings.

The present invention provides a hybrid cord formed in a 1+N structure in which a core wire is wrapped with a side wire, and N is an integer of 3 to 15, and the core wire is formed of at least one selected from the group consisting of polyethylene terephthalate fiber, polypropylene fiber, polyester fiber, polyvinyl chloride fiber, polyketone fiber, carbon fiber, and dried aramid fiber, and the side wire is a steel wire.

FIG. 2 is a view illustrating various structures of the hybrid cord in accordance with the present invention.

Hereinafter, the hybrid cord in accordance with the present invention will be described in detail with reference to the drawing.

As illustrated in FIG. 2, the hybrid cord in accordance with the present invention is formed in the 1+N structure in which the core wire is wrapped with the side wire, wherein N may be an integer of 3 to 15.

The core wire is formed of fiber, and the fiber may be a multi-filament formed of a bundle of large-diameter mono-filament fibers or fine-diameter mono-filament fibers.

When the multi-filament formed of a bundle of the fine-diameter mono-filament fibers is used as the fiber, moisture may be moved between the fine-diameter mono-filament fibers due to a capillary phenomenon, and thus the cord may be corroded. To prevent this corrosion, the multi-filament may be impregnated with a thermosetting resin or a thermoplastic resin so as to fill a space between the filament fibers, or may be treated through a water repellent process so as to prevent permeation and movement of the moisture.

Also, it is preferable that the fiber should not corrode the steel wire used as the side wire of the cord, and also hardly absorb the moisture.

An example of such a fiber may include polyethylene terephthalate fiber, polypropylene fiber, polyester fiber, polyvinyl chloride fiber, polyketone fiber, carbon fiber, and dried aramid fiber, and the core wire may be formed of at least one selected therefrom.

Also, a diameter of the core wire is not specifically limited, but may be 0.15 to 0.7 mm.

Meanwhile, the side wire may be the steel wire, and a carbon content thereof may be 0.6 to 1.05 weight %.

Also, a diameter of the side wire may be 0.15 to 0.5 mm, and a pitch interval of the side wire may be 12 to 18 mm, but is not limited thereto.

In the hybrid cord, the diameter of the core wire is selected so that a gap between the side wires is maintained at a value of 0.01 mm or more and rubber permeates into the gap, and thus fretting wear does not occur between the side wires, and a fretting phenomenon occurs only between the side wire formed of the steel wire and the core wire formed of the fiber. In this case, the fiber which is relatively softer and weaker than the steel wire serves as a cushion, and the fretting phenomenon is relieved, and occurrence of the wear is restricted, and also reinforcing performance of the cord is not lowered overall.

Hereinafter, examples of the present invention will be described in detail. However, these examples can be used to specifically describe the present invention, but the scope of the present invention is not limited to the examples.

### EXAMPLE 1

A wire rod formed of carbon steel having a carbon content of 0.9% was treated by drawing and heating processes, and a wire drawing process was finally performed to have a diameter of 0.38 mm, and thus a steel wire was prepared. Then, the steel wire was twisted with one core wire formed of polypropylene terephthalate fiber, and thus a hybrid cord having a structure in which the core wire and the side wire were 1×0.55+7×0.38 was manufactured.

### COMPARATIVE EXAMPLE 1

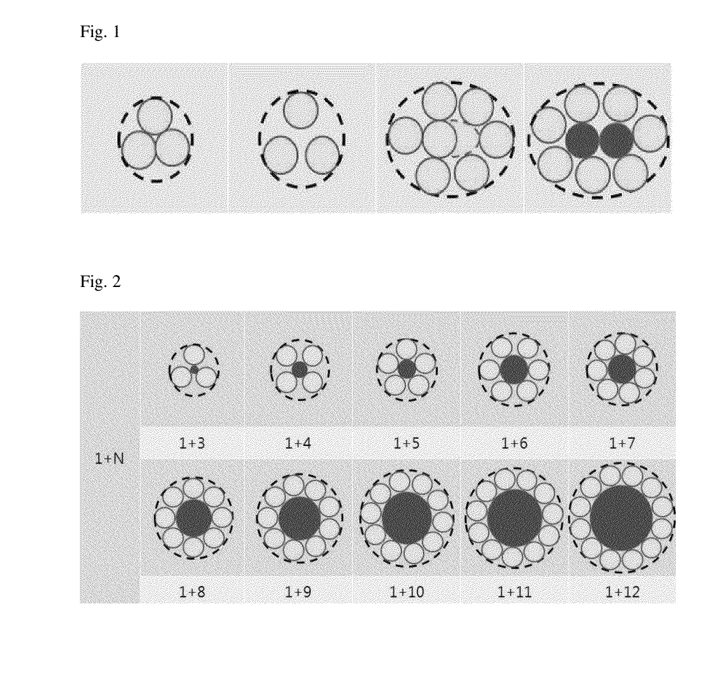

A wire rod formed of carbon steel having a carbon content of 0.9% was treated by drawing and heating processes, and a wire drawing process was finally performed to have a diameter of 0.35 mm, and thus a filament was prepared. Then, two core wires were firstly twisted, and then the twisted core wires were twisted again with seven side wires, and thus a steel cord (referring to FIG. 1) having a structure in which the core wire and the side wire were 2×0.35+7×0.35 was manufactured.

### EXPERIMENTAL EXAMPLE 1

### Measurement of Degree of Fatigue Resistance

A degree of fatigue resistance was measured using a rotating beam tester (RBT, manufactured by Bekaert Corp.), and results thereof were shown in Table 1.

### EXPERIMENTAL EXAMPLE 2

### Evaluation of Initial Adhesive Strength

Specimens for evaluation of adhesive strength were manufactured according to ASTM D2229-85 using the hybrid cord manufactured in Example 1, the steel cord manufactured in Comparative Example 1, and rubber. The manufactured specimens were cured for 20 minutes in a heating plate type curing press in which a pressure of 160° C., 15 kg/cm² was maintained, and left for 8 hours in the atmosphere, and then an adhesive experiment was performed according to an adhesive strength testing method of ASTM D2229-79 using a tensile tester.

The adhesive strength was evaluated with a force necessary to extract the cord adhered to molded rubber, and results thereof were shown in Table 1.

### EXPERIMENTAL EXAMPLE 3

### Evaluation of Aged Adhesive Strength

The specimens for evaluation of adhesive strength manufactured according to Experimental Example 2 were respectively left for 21 days under three kinds of aged adhesive strength test conditions (heat aging (95° C)., humidity aging (85° C., a humidity of 85%), and salt bath aging (20%)), and the aged adhesive strength was measured in the same method as that in Experimental Example 2, and results thereof were shown in Table 1.

TABLE 1

| | | | Comparative |
|---|---|---|---|
| | | Example 1 | Example 1 |
| Physical | Diameter of cord (mm) | 1.30 | 1.36 |
| properties | Unit weight (g/m) | 6.71 | 6.95 |
| | Pitch (mm) | 15.5 | 15.3 |
| | BF (Kgf) | 252 | 255 |
| | Elongation (%) | 3.1 | 2.8 |
| | LLE (%) | 0.02 | 0.04 |
| Fatigue | RBT | 10,400 | 10,300 |
| resistance | (test load: 150 kg/mm²) | | |
| (cycle) | | | |
| Initial | Normal curing | 139 | 121 |
| adhesive | | | |
| strength | | | |
| (kgf) | | | |
| Aged | Heat aging (95° C.) | 90 | 88 |
| adhesive | Humidity aging | 52 | 51 |
| strength | (85° C., 85%) | | |
| (kgf) | Salt bath aging (20%) | 116 | 111 |

According to the present invention, since the core wire and the side wire are formed of different materials having different strength, and also the diameter of the core wire is selected so as to increase the gap between the side wires, the fretting wear between the side wires can be prevented, and the rubber permeation into the core wire can be enhanced, and also even when the tread cut occurs and the moisture permeates therein, the movement of the moisture can be prevented, and thus the corrosion of the steel cord can be prevented. Also, since it is possible to form the tightly twisted structure, the reduction of the strength can be prevented, compared with the open cord, and the dimensional stability can be enhanced.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A hybrid cord formed in a 1+N structure in which a core wire is wrapped with a side wire, and N is an integer of 3 to 15,
wherein the core wire is selected from the group consisting of polyethylene terephthalate fiber, polypropylene fiber, polyester fiber, polyvinyl chloride fiber, polyketone fiber, carbon fiber, and dried aramid fiber, and
the side wire is a steel wire.

2. The hybrid cord of claim 1, wherein the core wire is a multi-filament formed of a bundle of large-diameter mono-filament fibers or fine-diameter mono-filament fibers.

3. The hybrid cord of claim 2, wherein the multi-filament formed of a bundle of the fine-diameter mono-filament fibers is impregnated with a thermosetting resin or a thermoplastic resin.

4. The hybrid cord of claim 1, wherein a diameter of the core wire is 0.15 to 0.7 mm, and a diameter of the side wire is 0.15 to 0.5 mm.
